(19) United States
(12) Patent Application Publication
(10) Pub. No.: US 2008/0140443 A1
(43) Pub. Date: Jun. 12, 2008

(54) Method and apparatus for automatically providing dental patients with a fresh toothbrush in a timely manner

(76) Inventor: Steven D. Kaminsky, Wayland, MA (US)

Correspondence Address: Mark J. Pandiscio;Pandiscio & Pandiscio, P.C., 470 Totten Pond Road, Waltham, MA, 02451-1914, US

(21) Appl. No.: 10/700,160

(22) Filed: Nov. 3, 2003

Related U.S. Application Data
(60) Provisional application No. 60/423,153, filed on Nov. 2, 2002.

(51) Int. Cl. G06Q 50/00; G06Q 10/00; G06Q 90/00

(52) U.S. Cl. 705/2; 705/1

(57) ABSTRACT

A method is disclosed for automatically providing a dental patient with a fresh toothbrush, the method comprising collecting identifier information for the dental patient, the identifier information including dental office, previous hygiene appointment date and future hygiene appointment date, preparing a mailing package containing the fresh toothbrush with a reminder notice of the future hygiene appointment at the dental office, and sending the mailing package to the patient on a given date based on a time interval from the previous hygiene appointment date.

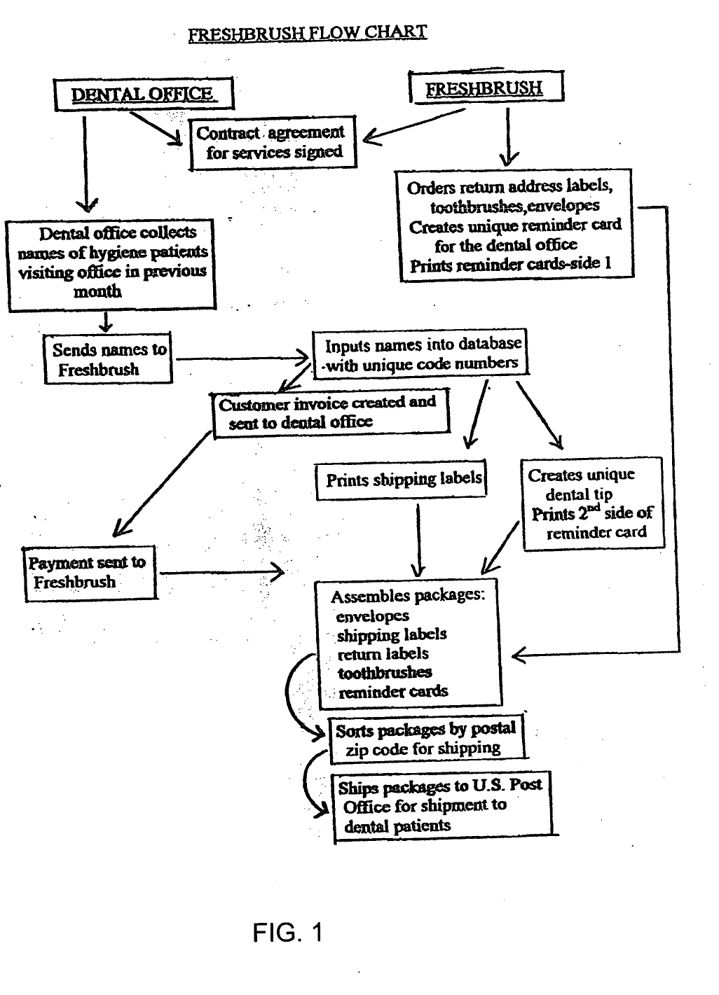

A system is disclosed for automatically providing a dental patient with a fresh toothbrush, the system comprising data collection means for collecting the patient name together with a previous hygiene appointment date, packaging means for preparing a mailing package containing the fresh toothbrush, and calculating means for determining a given date to send the mailing package to the patient based on the previous hygiene appointment date.

### REFERENCE TO PENDING PRIOR APPLICATION

This patent application claims benefit of pending prior U.S. Provisional Patent Application Ser. No. 60/423,153, filed Nov. 2, 2002 by Steven Kaminsky for METHOD AND APPARATUS FOR AUTOMATICALLY PROVIDING DENTAL PATIENTS WITH A FRESH TOOTHBRUSH IN A TIMELY MANNER (Attorney's Docket No. FRESH-1 PROV), which patent application is hereby incorporated herein by reference.

### FIELD OF THE INVENTION

This invention relates to the field of dentistry in general, and more particularly to methods and apparatus for automatically providing dental patients with a fresh toothbrush in a timely manner.

### BACKGROUND OF THE INVENTION

### The Toothbrush

Even though tooth cleaning instruments have existed since the time of the Pharaohs, the modern toothbrush (i.e., one handle with bristles) was first invented by the Chinese about 1500 AD. DuPont made various modifications to this tool over the years until a major breakthrough occurred in 1938, with the development of nylon and its use in the toothbrush as the primary cleaning apparatus for dental hygiene.

Throughout most of the 20th century, two manufacturers, Oral-B® and Butler®, were the primary producers of toothbrushes in the United States. However, since 1994, Johnson and Johnson®, Colgate-Palmolive®, Beechem Products®, Proctor and Gamble®, and Cheesborough-Ponds® have all entered the toothbrush market and have become major players in the supply of toothbrushes to the American public. According to research conducted by Leading Edge of Commack, N.J., as of 1996, the toothbrush industry has become a $635 million annual market, with the projection of surpassing $1 billion in annual sales by the 21st century.

Developments in technology and market competition have combined to produce a vast variety of choices in toothbrush type and design (hard or soft bristles, size and shape of head, angle of head to handle, fixed or movable head, angle and length of bristles, color and style of handle, markings and novelty design of handles, etc.).

This explosion in the sales and marketing of the toothbrush can best be understood by reviewing the change in demographics of the dental population in the 20th century.

### Dental Demographics

In the last half of the 20th century, the profile of the typical dental patient has tended to fall into one of two categories.

The first category, age 40 and above, are those with increased demands in restorative procedures. These patients are fundamentally different than other age groups. While growing up, a majority of these individuals did not have the luxury of fluoridation in their water supply and thus had a high rate of caries (dental decay). However, they still had the availability of other advances in dentistry and thus have been able to maintain their teeth through a variety of sophisticated procedures. This group developed the expectation of retaining their natural teeth as the norm. Even those patients who suffered the fate of extraction have changed their viewpoint, and are now opting for more sophisticated permanent replacements such as implants. This entire population group has not only exploded in shear number, but they also require more frequent, regular, and often very expensive forms of treatment to maintain their dentition. It therefore follows that they, as a group, are not only willing, but also demanding, the highest form of dental prevention. They have both the motivation and disposable income to do this.

The second major demographic group to develop in the last decades of the 20th century is the young adults, ages 35 and younger. This population group has been able to not only benefit from the advances and sophistication of the dental restorative office, but has also been the main recipient of the benefits of fluoride and sealants. They have been able to avoid major incidences of dental caries and therefore reduce dramatically the need for restorative services. However, despite the diminished need for exotic dental procedures, they have become more sophisticated in their quest for esthetic dentistry and the perfect smile. This group will also demand the highest quality in dental home care in order to maintain their appearances.

This change in dental health has increased the demand for effective, and aesthetically pleasing, toothbrushes.

### The Changing Dental Practice

The aforementioned change in dental health is also affecting the practice of dentistry.

More particularly, it is anticipated that over the next several decades, there will be a slowly declining per capita need for restorative and surgical dental care. Extensive restorative procedures and periodontal treatment will be less prevalent as population demographics change. Younger age groups will create less demand for these services than prior generations. The overall mix of services will continue to shift toward diagnostic and preventive services. This decline in demand for restorative dental treatment will allow the average dentist to treat more patients and a larger percentage of their practice income will be derived from diagnostic, preventive and elective services. These areas will come to dominate the typical dental practice in much the same way that restorative services have dominated dental practices in the past. With a decrease in the number of “high-need” patients, and an increase in the number of people with little disease experience and minimal guidance, there will be an increasing need for the dental practice to maintain greater patient contact and retention. Thus, the ability to communicate with the patient on a regular basis will be of the utmost importance in successfully maintaining the doctor-patient relationship.

In the 2000 Surgeon General's Report on America's Oral Health, it is stated that “Oral health is essential to the general health and well-being of all Americans, and this improved oral health can be achieved by all Americans.” The report highlights the importance of oral structures to the quality of life. The American public is increasingly aware of the interaction between oral health and general well-being, and is placing a higher demand on the practitioner to deliver a higher standard of dental health. Patients now not only expect to keep their teeth, avoiding previous generations' edentulism, but also demand caries-free, perfectly-aligned, dazzling white smiles. Patient satisfaction is the key to a successful dental practice, and dental professionals must find new, innovative ways to address these patient demands for new and improved methods of delivering dental health. The toothbrush has an important role to play in providing this improved dental health.

### The Toothbrush and Improved Health

A recent study by the American Dental Association revealed that most Americans do not replace their toothbrushes nearly as often as they should. It is recommended that the average consumer replace their toothbrush at least every three months. Unfortunately, however, this recent study reports that most individuals just do not know when to change their toothbrush. Most often, individuals only replace the worn-out “relic” in the bathroom after visiting the dentist at a yearly recall appointment and receiving a complementary toothbrush. While the average Japanese consumer changes their toothbrush every three months, the typical American replaces his or her toothbrush only every nine months or so.

However, this is not due to indifference. A Crest Complete survey in 1993 showed that 94% of all Americans brush every night, and a research study by Proctor and Gamble showed that “. . . the first thing people want is a brush that thoroughly cleans teeth.” Patients have become much more conscious of their toothbrush and the fact that it can become a repository for germs. In 1993, Glass and Shapiro found that patients who change their toothbrush at least monthly improved their chronic and persistent oral infections more rapidly and stayed healthier longer than those who did not. “Toothbrushes act as reservoirs for microorganisms capable of producing inflammatory diseases including gingivitis and periodontitis.” They also recommended that people who are sick should change their brush when they feel better, and again when they feel completely well. This helps eliminate the toothbrush as a source of reinfection. In his June, 2000 article, Drisko reports “. . . good home oral hygiene is still the most effective tool for maintaining health and for preventing periodontal disease.” The American Dental Association, American Dental Hygiene Association, Massachusetts Dental Society, California Dental Society, and Chicago Dental Society, as well as many other dental organizations, all recommend replacing the old toothbrush with a new one at least every three months and more often for children. Several educators and research dentists often recommend monthly replacement for adults as well. Most dentists and their dental patients will commonly agree that they should change their toothbrush more often, yet they typically do not.

It is believed that there are several reasons for this.

(1) Opportunity. Most people only replace their toothbrush with the one given to them by the dentist at a recall appointment, which could be as often as 6 months or as infrequent as one year.

(2) Motivation. The average consumer is never required to replace the old brush, which never seems to change much from day to day. Unlike a razor blade, which can nick and cut when dull, a worn toothbrush never seems to be harmful. In actuality, it can cause extensive damage to teeth and gums with worn, splayed bristles.

(3) Inertia. For the general population, “a change in hygiene” is better served by an external force. People are typically reluctant to do anything unless it is required. The average person will replenish a missing item when it is gone (e.g., toothpaste or toilet paper) but will not be as conscientious about replacing an item when it wears out slowly (e.g., their toothbrush).

(4) Confusion. With the wide variety and number of models to choose from, the selection of a toothbrush can be very confusing to a consumer. Too many choices can lead to a fear of poor selection, and will often promote stagnation and maintenance of the status quo. The patient wonders whether they are making the proper choice, and many times feel uncomfortable placing themselves in the hands of the marketing machine of a manufacturer. An important reason dentistry is held in such high regard by the public is that it has been seen through the years as having the best interest of the patient as central to its reason for being. People trust their dentist and, more often than not, will do as they are instructed.

### The Toothbrush Dilemma

Thus we have the toothbrush dilemma:
it is used at least once a day by 98% of all Americans, and in many cases 2-3 times per day
it is used in one of the dirtiest, most infected parts of the human body, with only a rinse of water for cleaning
it is seldom replaced, except for its yearly dismissal when given a new substitute

In essence, although it is the most frequently utilized member of a person's personal hygiene toolbox, the toothbrush is often overlooked, under-appreciated, and dismissed in its role as the single most important part of one's personal oral hygiene. No other dental appliance has as significant an impact on the oral health of an individual as the toothbrush, yet most Americans do not have the time, inclination or motivation to replace this important tool as often as necessary.

The present invention is intended to address this situation.

### SUMMARY OF THE INVENTION

FRESHBRUSH® is a unique, innovative service offered to the dental profession as the ultimate provider of superior home oral hygiene, by automatically providing the patient with an ADA-approved, new, fresh toothbrush periodically, as directed by the dental care provider. FRESHBRUSH® will enable everyone to “win”.

The Dental Patient. The dental patient will be receiving the ultimate in oral home care—a limitless source of fresh, new toothbrushes. They will be able to maintain their health with the very best available dental instrument. They will be sent, via mail, a new brush and will not need to decide which brush to buy or when to buy it. “Out with the old, in with the new”. They will become more motivated in their quest for oral health and will become more appreciative of their dentist's interest in them. The program will be able to offer any variety of toothbrushes specifically appropriate for the patient, affording them the use of the very best brush for their particular situation. Ultimately, by having a cleaner, healthier mouth, the patient will experience a higher state of general well-being.

The Dentist. The dentist will be able to provide his or her patient the very best ADA-approved toothbrush automatically, without any extra effort from his or her staff. Each brush will be delivered with the name of the dentist designated in the return address portion, thereby providing direct communication between the patient and the office. The periodic arrival of a new brush will invigorate and motivate the patient to seek the very best in dental care by the dentist. Each mailing of a new brush will be accompanied by an educational adjunct, thus reinforcing the dentist's role as supreme provider of dental knowledge. The cost structure of this service will provide a new, infinite source of revenue to the practice, at no extra investment by the dentist.

The Insurance Provider. For the insurance provider, the incorporation of FRESHBRUSH® into a dental practice will increase the level of dental health and preventive services, and thus will reduce the need for more exotic and costly treatment. This will save millions of dollars per year in the cost of treatment benefits. These savings will be reflected not only by improved dental health, but also, as the Surgeon General points out, by an improvement in general health.

### DETAILED DESCRIPTION OF THE INVENTION

### Recall Program

The recall program includes general, pedodontic, and periodontal practices. It generally consists of the following steps.

(1) The dental office registers for the FRESHBRUSH® program, supplying specific practice and/or dentist names and the address of the practice. Return address labels are then manufactured by FRESHBRUSH® for application to each package sent out on behalf of this practice. In addition, FRESHBRUSH® will customize the appropriate reminder card to be sent to each patient with the toothbrush, i.e., it will refer to that particular office. The reminder cards will have a new dental health tip each month on the reverse side.

(2) Each month, the dental practice collects the names of all the patients seen in the office for a hygiene appointment. The patient names may be collected daily or at the end of the month; and may be generated manually or via computer software (e.g., using a dental procedure code number). Each patient's name, mailing address, and toothbrush classification (adult or youth) is included on this list.

(3) The complete list of names, etc. is sent to FRESHBRUSH® via mail, fax or as an attachment in E-mail format.

(4) Each name is entered into the system, and assigned the appropriate code number for processing. The code number is designated as “dentist name”, “YYMM” and “Y/A”, where YY and MM represent the year and month three months after the patient's last hygiene appointment, and Y/A represent youth or adult toothbrush. For example: Dr. Smith's office sends a list of patients from their May, 2002 hygiene appointments. The code number would be “SMITH0208/A”.

(5) Shipping labels are printed by FRESHBRUSH® with each patient's name, address, and code number.

(6) The packages are prepared by affixing a return address label and a shipping label to the front of a #00 white bubble lined envelope, and inserting a toothbrush and reminder notice inside the envelope. Siblings receiving the same size toothbrush within the same month will be sent different colors.

(7) The envelopes are sealed, sorted by zip code, and mailed by Unites States Postal Service.

(8) The dental office is sent an invoice for the number of patients on that month's list, and the invoice is payable within 30 days of billing date.

### Orthodontic Program

(1) Same as Item (1) above.

(2) Each month, the orthodontic practice generates a list of all of the patients having started active treatment. Each patient's name, mailing address, and date of birth is included on the list.

(3) Same as Item (3) above.

(4) Each name on the list is entered into the system, and assigned the appropriate code number for processing. The code number is designated as “dentist name”, “YYMM” first brush sent, “YYMM” 24 months later, and “A/Y”. If the patient will be transitioning across a selected cutoff age for youth vs. adult size toothbrush, the code number will include another set of “YYMM” information designating the time of transition. For example: Tom Thumb starts orthodontic treatment in May, 2002 when he is 11 years old. His birth date is Feb. 28, 1991. The code number for Tom Thumb will be:
“SMITH0205/0301Y/0404A”. Tom will receive a youth toothbrush from May, 2002 through January, 2003, and he will then receive an adult toothbrush until completion of his program in April, 2004.

(5) Same as Item (5) above.

(6) Same as Item (6) above.

(7) Same as Item (7) above.

(8) Same as Item (8) above.

(9) At the end of the 24 month period, FRESHBRUSH® will contact the dental office for optional continuation of the program for each patient, as needed.

### Coordination with Dental Patient's Hygiene Schedule

Significantly, one aspect of the present invention is that it coordinates the supply and changing of the toothbrush with the dental patient's hygiene schedule, as opposed to some arbitrary calendar event. In other words, the supply and changing of the toothbrush is specifically linked to the dental patient's personal hygiene schedule, and is not sent on some arbitrary quarterly, semiannual or other calendar schedule.

### Program Extensions

It should, of course, be appreciated that various modifications may be made to the preferred embodiment described above without departing from the scope of the present invention.

Thus, for example, the invention could be used to supply objects other than toothbrushes to the patients, e.g., it can be used to supply other dental supplies. For example, it could be used to supply dental consumables such as toothpaste.

These and other changes of this type are considered to be within the scope of the present invention.

What is claimed is:

1. A method for automatically providing a dental patient with a fresh toothbrush, the method comprising:
collecting identifier information for the dental patient, the identifier information including dental office, previous hygiene appointment date and future hygiene appointment date;
preparing a mailing package containing the fresh toothbrush with a reminder notice of the future hygiene appointment at the dental office; and
sending the mailing package to the patient on a given date based on a time interval from the previous hygiene appointment date.

2. A system for automatically providing a dental patient with a fresh toothbrush, the system comprising:
data collection means for collecting the patient name together with a previous hygiene appointment date;
packaging means for preparing a mailing package containing the fresh toothbrush; and
calculating means for determining a given date to send the mailing package to the patient based on the previous hygiene appointment date.
